(19) United States
(12) Patent Application Publication
(10) Pub. No.: US 2005/0270381 A1
(43) Pub. Date: Dec. 8, 2005

(54) System and method for improving image capture ability

(76) Inventors: James Owens, Fort Collins, CO (US); James S. Voss, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/861,804

(22) Filed: Jun. 4, 2004

(51) Int. Cl. H04N 5/228

(52) U.S. Cl. 348/222.1

(57) ABSTRACT

In one embodiment, there is shown a method for improving image capturing ability, such that contemporaneously with the initial capture of an image, metadata contained within the captured image is analyzed to determine which, if any, image capture parameters are in need of adjustment. The images are stored when the metadata contained therein does not yield image capture parameters in need of adjustment.

### FIELD OF THE INVENTION

This invention relates generally to image capturing and more particularly to systems and methods improving the users image capture ability by analyzing metadata associated with the digital images during the image capturing process.

### BACKGROUND OF THE INVENTION

Digital image capture devices, such as a digital camera, allow a user a great deal of flexibility in their use. This flexibility arises during the image capture process and extends through all aspects of image viewing and image storing. One feature now often taken advantage of during image capture is the ability of the user to instantly review the captured, or about to be captured, image. This review then allows the user (or in some situations, allows the image capture device without human intervention) to adjust the image capture parameters before storing an image.

When an image is captured by a digital image capture device, metadata is often retained within the image. This metadata can comprise a very rich information source and may be associated with the capture device, the capture image, and can include image capture device settings and measurements. In general, metadata is any data associated with a file other than the data normally visible to the user of that file. Many modern digital cameras utilize the “Exchangeable image file (Exif) format for digital still cameras: as shown in Exif version 2.2 published by the Standard of Japan Electronics and Information Technology Industries Association, which publication is hereby incorporated by reference herein. Exif version 2.2 allows for the association of a rich metadata, herein referred to as image capture parameters, with each image.

The user may employ a software application to access the metadata for additional uses. For example, the metadata may contain global positioning system (GPS) information, and a user may then organize the images, store the images, or search the images using this GPS information. Further, if the user detects problems with captured images, or wishes to make image enhancements, the user may reference the metadata contained within the image to make corrections in the images. The time stamp metadata could be used, for example, to find an image (or set of images) captured on a certain date. As discussed above, this metadata is often stored in a standard format called Exif 2.2, as shown in Addendum 1.

### BRIEF SUMMARY

In one embodiment, there is shown a method for improving image capturing ability, such that contemporaneously with the initial capture of an image, metadata contained within the captured image is analyzed to determine which, if any, image capture parameters are in need of adjustment. The images are stored when the metadata contained therein does not yield image capture parameters in need of adjustment.

According to another embodiment, there is shown a system for providing image improvement assistance for images having associated therewith metadata pertaining to certain image capture parameters. The system comprises analyzation capability for examining the metadata associated with an image that is in the process of being stored, and reporting image improvement assistance for an image to a user based upon the analyzation of the metadata associated with that image.

### BRIEF DESCRIPTION OF THE DRAWINGS

FIG. 1 shows a flow chart of one embodiment of a process for controlling image capture;

FIGS. 2 and 3 show an embodiment of an image capture device; and

FIG. 4 shows one embodiment of a display message.

### DETAILED DESCRIPTION

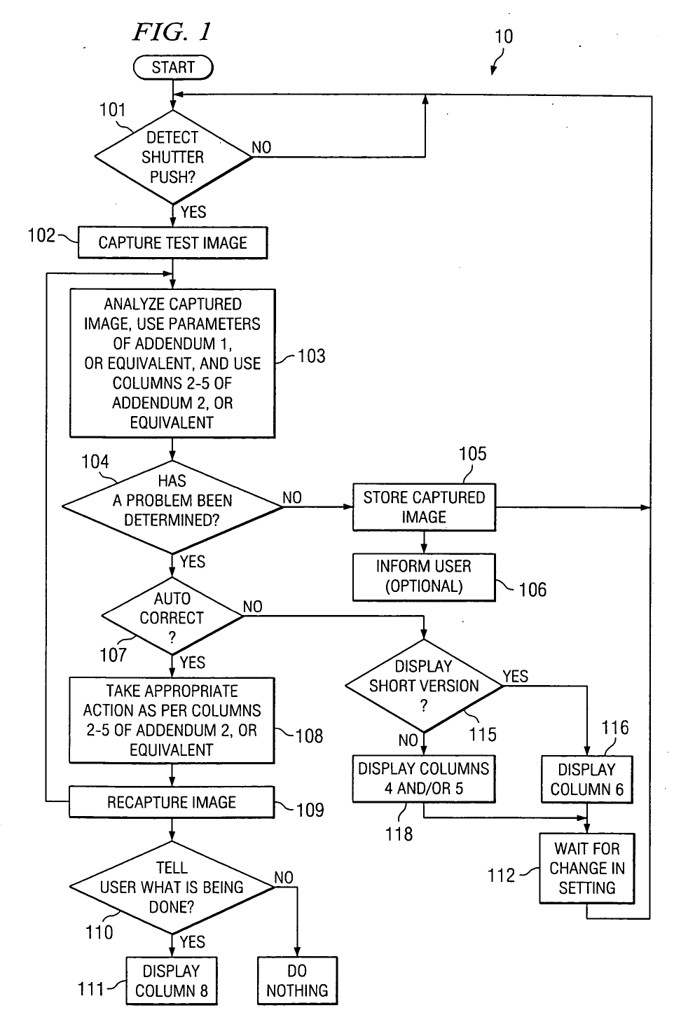

Turning now to FIG. 1, there is shown flow chart 10 of one embodiment of a process for providing image analyzation while the image is being captured and initially stored. Process 101 detects a shutter push and in conjunction with process 102 captures an image. This image will have associated with it metadata pertaining to any number of parameters, as detailed in the above-referenced Exif 2.2 specification, as shown in Addendum 1 hereof. Addendum 1 is but one example of the types of metadata that are available, and many other types of data could be established. If desired, the particular parameters that are analyzed can be selected by users.

Some of the parameters that could be examined can be, for example, use of image width, image height, number of bits per component, compression scheme, pixel composition, orientation of image, number of components, image data arrangement, subsampling ratio of Y to C, Y and C positioning, image resolution in width direction, image resolution in height direction, unit of X and Y resolution; image data location, number of rows per strip, bytes per compressed strip, offset to JPEG SOI, bytes of JPEG data, transfer function, white point chromaticity, chromaticities of primaries, color space transformation matrix coefficients, pair of black and white reference values, file change date and time, image title, image input equipment manufacturer, image input equipment model, software used, person who created the image, copyright holder.

Process 103 analyzes the captured image and the metadata contained therein using columns 1 and 2 of the chart attached hereto as Addendum 2.

Process 104 uses logic well-known to those skilled in the art and based on the detected image capture parameters (as contained in the imbedded metadata) compared against known acceptable image capture parameters to determine whether a “problem” is present with the image. If there is no problem, then the image is stored under control of process 105. If desired, the user is so informed under control of process 106. If, however, a problem has been determined, then process 104 calls upon process 107 to determine whether auto recapture (correct) should occur. Note that a problem in the context discussed herein is not necessarily a faulty image but rather an image, the quality of which the system has determined could perhaps be improved upon by a change of a device or image parameter. For example, a correction might be to use a flash or by changing the settings or the image capture speed. Also note that in the context of process 105, storage is the type of storage that would occur when an image is to be saved, at least semi-permanently. This is opposed to temporary image storage during the capture process itself. Also note that the reporting of the image improvement information is done contemporaneously with the image storage, i.e., during or directly following the storage of the image.

Further, if the image is deemed unacceptable through analysis of the metadata and/or analysis of the image itself, the system would optionally provide instructions to the user for improving a subsequent image. Additionally, if the image is deemed unacceptable, the user could select an option for the camera to automatically adjust one or more image capture settings and recapture one or more images until the captured image is deemed satisfactory.

If auto correct has been established, then process 108 takes the appropriate action, for example, as per column 3 of Addendum 2, and process 109 recaptures the image. By way of example, and referring to Addendum 2, line 1, and using logic well-known to those skilled in the art, assume that it has been determined (based on imbedded metadata) that an image is a high contrast scene. Under this scenario, the action contemplated by line 1, column 3 would electronically occur thereby resulting in adaptive lighting being used during the image recapture process. Note that adaptive lighting in digital photography is a technique similar to “dodge and burn” in traditional film photography. If desired, processes 110 and 111 control the display of the “correction” message to the user.

Once the image is recaptured, processes 103, 104, 107 are followed until such time as process 104 determines that further parameter adjustments are not likely to improve image quality. Then process 105 stores the image as discussed above.

If process 107 determines that auto correct is not on, this then would imply that the user desires to maintain control over the capturing of images, and process 115 optionally determines whether a short version (column 6) or a longer version (column 4 or 5) of the instructions is to be provided to the user. This, of course, is an option and only one version need be provided.

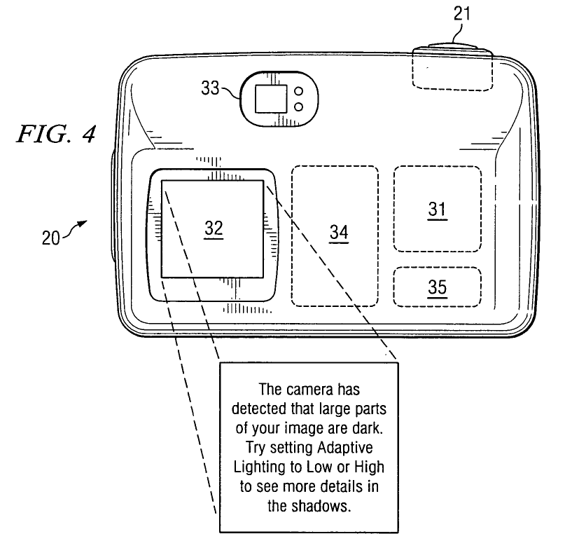

Assuming the long version is to be provided, then the message from Addendum 2 row 1, column 5 is displayed. This is shown on display 32 (FIG. 4). Processes 115 and 118 (FIG. 1) control the display of the graphical user interface (GUI) version of the message to the user. The system would then wait for the user to make the parameter changes suggested, or to make any other changes the user desires. The image would then be recaptured and the system would be operated as discussed above until such time as “problems” have been eliminated from the image. Note that the message to the user could be text, graphics, or verbal, as desired.

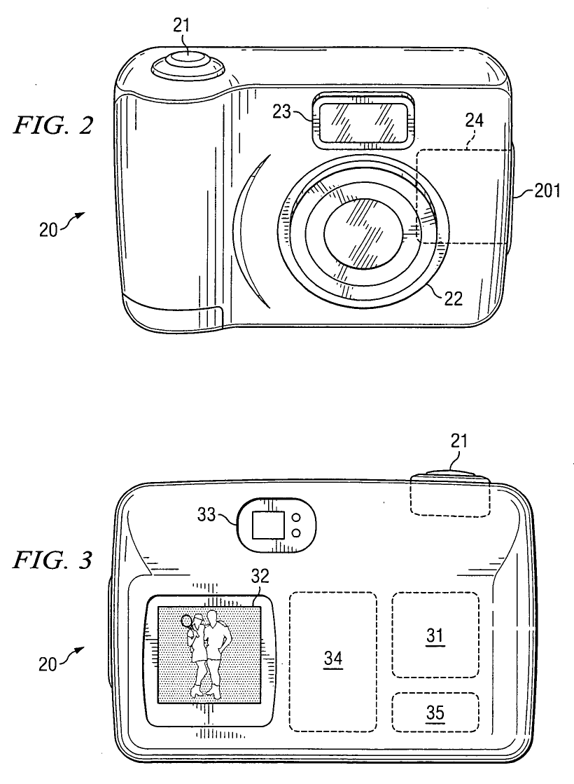

FIG. 2 shows the front view of one embodiment of image capture device 20. In this situation, the device is a digital camera having shutter control button 21, lens 22, alternate viewer 23, and memory card 24 inserted in slot 201. The image capture device could be a video camera, a PDA, cell phone or any device that captures image data.

FIG. 3 shows the back view of camera 20 having display 32 for showing captured (or about to be captured) images to the user. Inside the camera there is at least one sensor 34 that can be a charge-couple device (CCD) or other type of sensor for capturing the image. There is also shown the back portion 33 of the auxiliary window, as well as processor 31 and memory 35. Memory 35 could, if desired, be separate from memory card 34. Processor 31 could be used, if desired, to run the processes discussed above with respect to FIG. 1, as well as many other image control processes. Power for camera 20, such as a battery, is not shown.

ADDENDUM 1

| | | Tag ID | | | |
|---|---|---|---|---|---|
| Tag Name | Field Name | Dec | Hex | Type | Count |
| (A) Tags relating to image data structure | | | | | |
| Image width | ImageWidth | 256 | 100 | SHORT or LONG | 1 |
| Image height | ImageLength | 257 | 101 | SHORT or LONG | 1 |
| Number of bits per component | BitsPerSample | 258 | 102 | SHORT | 3 |
| Compression scheme | Compression | 259 | 103 | SHORT | 1 |
| Pixel composition | Compression | 262 | 106 | SHORT | 1 |
| Orientation of image | PhotometricInterpretation | 274 | 112 | SHORT | 1 |
| Number of components | SamplesPerPixel | 277 | 115 | SHORT | 1 |
| Image data arrangement | PlanarConfiguration | 284 | 11C | SHORT | 1 |
| Subsampling ratio of Y to C | YCbCRSubSampling | 530 | 212 | SHORT | 2 |
| Y and C positioning | YcbCrPositioning | 531 | 213 | SHORT | 1 |
| Image resolution in width direction | XResolution | 282 | 11A | RATIONAL | 1 |
| Image resolution in height direction | Yresolution | 283 | 11B | RATIONAL | 1 |
| Unit of X and Y resolution | ResolutionUnit | 296 | 128 | SHORT | 1 |
| (B) Tags relating to recording offset | | | | | |
| Image data location | StripOffsets | 273 | 111 | SHORT or LONG | *S |
| Number of rows per strip | RowsPerStrip | 278 | 116 | SHORT or LONG | 1 |
| Bytes per compressed strip | StripByteCounts | 279 | 117 | SHORT or LONG | *S |
| Offset to JPEG SOI | JPEGInterchangeFormat | 513 | 201 | LONG | 1 |
| Bytes of JPEG data | | 514 | 202 | LONG | 1 |
| JPEGInterchangeFormatLength | | | | | |
| (C) Tags relating to image data characteristics | | | | | |
| Transfer function | TransferFunction | 301 | 12D | SHORT | 3 * 256 |
| White point chromaticity | WhitePoint | 318 | 13E | RATIONAL | 2 |
| Chromaticities of primaries | PrimaryChromaticities | 319 | 13F | RATIONAL | 6 |
| Color space transformation matrix | YCbCrCoefficients | 529 | 211 | RATIONAL | 3 |
| coefficients | | | | | |
| Pair of black and white reference | ReferenceBlackWhite | 532 | 214 | RATIONAL | 6 |
| values | | | | | |
| (D) Other tags | | | | | |
| File change date and time | DateTime | 306 | 132 | ASCII | 20 |
| Image title | ImageDescription | 270 | 10e | ASCII | Any |
| Image input equipment manufacturer | Make | 271 | 10f | ASCII | Any |
| Image input equipment model | Model | 272 | 110 | ASCII | Any |
| Software used | Software | 305 | 131 | ASCII | Any |
| Person who created the image | Artist | 315 | 13b | ASCII | Any |
| Copyright holder | Copyright | 33432 | 8298 | ASCII | Any |

*S Chunky format: StripsPerImage
Planar format: SamplesPerImage * StripsPerImage
StripsPerImage = floor((ImageLength + RowsPerStrip − 1)/RowsPerStrip

ADDENDUM 2

| | | How Problem | | | | |
|---|---|---|---|---|---|---|
| | Problem | Detected | Scene/Device | GUI String | Advice | Short Version |
| | (1) | (2) | (3) | (4) | (5) | (6) |
| (1) | Picture is a high- | Use metadata to | High contrast scene, | HINT: This image is | The camera has | USE_{—} |
| | contrast scene | determine if the | back-lit subject, | of a scene with very | detected that large | ADAPTIVE_{—} |
| | | scene is high- | such as subject in | bright and very dark | parts of your image | LIGHTING |
| | | contrast and | shade with bright | regions. For a more | are dark. Try setting | |
| | | suggest using | background. | even look and to see | Adaptive Lighting to | |
| | | Adaptive Lighting. | Confirm focus lock. | more detail in the | low or high to see | |
| | | | Capture image. | dark regions, try | more details in the | |
| | | | (Wide & Tele) | setting Adaptive | shadows. | |
| | | | | Lighting to Low or | | |
| | | | | High. | | |
| (2) | Picture is taken with | Detect if strobe is | Set camera to Night | HINT: This image | Your camera strobe | Enum = NIGHT_{—} |
| | the strobe using | set to night mode. | flash on. | was taken using the | is set to night mode. | USE_TRIPOD |
| | Night mode | | Average indoor | Night flash setting, | Longer exposure may | |
| | | | lighting or dimmer | which typically | cause your image to | |
| | | | scene. | results in a long | appear blurry. | |
| | | | Confirm focus lock. | exposure. Long | Stabilize the camera | |
| | | | Capture image. | exposures often | using a tripod to | |
| | | | | cause images to be | avoid motion blur. | |
| | | | | blurry because it is | Not the correct | |
| | | | | hard to hold the | wording. Murray, | |
| | | | | camera still for more | what should we | |
| | | | | than 1/60 of a | say(?) | |
| | | | | second. To make | | |
| | | | | sure that the images | | |
| | | | | don't come out | | |
| | | | | blurry, use a tripod | | |
| | | | | when taking pictures | | |
| | | | | with the Night flash | | |
| | | | | setting. | | |
| (3) | Picture of people is | Detect if strobe is | 1) Set camera to | HINT: This image | The strobe fired in a | Enum = USE_{—} |
| | taken using the | set to a redeye | Portrait mode, with | may have people | in a scene where | REDEYE_{—} |
| | strobe. Suggest | mode or if camera is | flash on. (Wide & | with red eyes. If the | your subject may | CORRECTION |
| | using camera | set to portrait mode | Tele) | red eyes need to be | have red eyes. You | |
| | redeye correction if | and the strobe fired. | 2) Set camera to | removed, you can | may consider | |
| | not already done. | | Normal mode, with | use Remove Red | selecting the Remove | |
| | | | redeye flash | Eyes in the | Red Eyes | |
| | | | on. (Wide & Tele) | Playback menu to | enhancement in the | |
| | | | Subject should be a | correct the image. | playback menu. | |
| | | | portrait of one or | | | |
| | | | more persons, (try | | | |
| | | | camera at ˜30 | | | |
| | | | degree angle to | | | |
| | | | subject(s). | | | |
| | | | Confirm focus lock. | | | |
| | | | Capture image. | | | |
| | | | Run Image Advisor | | | |
| | | | to view message. | | | |
| | | | Run redeye | | | |
| | | | correction | | | |
| (4) | The user enables | Detect to see if the | Set camera to | HINT: This picture | Image blur is more | Enum = MACRO_{—} |
| | macro. It is highly | macro range is | Macro mode. | was taken with the | likely to happen in | USE_TRIPOD |
| | possible to get many | being used. | Mid-day, full-sun, | Macro focus setting. | macro. Although, not | |
| | out of focus or blurry | | any subject in macro | Focus is very | totally necessary | |
| | picture even when | | range. | sensitive in Macro, | unless the camera | |
| | the BV is bright | | Confirm focus lock. | so small movements | indicates the need for | |
| | enough. Therefore, | | Capture image. | toward or away from | flash, we would | |
| | I suggest we | | | the subject can | recommend the use | |
| | encourage the user | | | make the image out | of a tripod whenever | |
| | to get in the habit of | | | of focus and blurry. | you use macro | |
| | using a tripod as | | | For sharpest focus | images. Your images | |
| | much as possible | | | in Macro mode, use | will improve in focus | |
| | when shooting in | | | a tripod to hold the | and sharpness. | |
| | macro. | | | camera still. | | |
| (5) | If the user places | We would detect the | Set camera to | HINT: This image | In portraits that are | Enum = |
| | the camera in | portrait mode, and if | Portrait mode, set | was taken in Portrait | contrasty or may be | PORTRAIT_{—} |
| | Portrait mode we | the flash did not fire, | flash off. | mode and may have | backlit it may help to | ADAPTIVE_{—} |
| | can assume that | and if we know that | High-contrast scene, | shadows across the | use force the flash on | LIGHTING_{—} |
| | they are taking | there was a fair | such as subject in | subject. To create | or even use the low | LOW |
| | pictures of people | degree of successful | shadow with bright | the appearance of | Adaptive Lighting | |
| | and can offer image | pushdown, we could | light in background. | more even lighting, | setting | |
| | improvements | deduce that this | Confirm focus lock. | use the Flash On | | |
| | | could be a high | Capture image. | setting or set | | |
| | | dynamic range | (Wide & Tele) | Adaptive Lighting to | | |
| | | scene that may | | Low. | | |
| | | benefit from Retinex | | | | |
| | | or forced flash | | | | |
| (6A) | Picture is taken | We would detect the | Set camera contrast, | HINT: This image | Contrast saturation | Enum = |
| | using combinations | saturation, | sharpness & | was taken with | and sharpness are | MANUAL_{—} |
| | of the high setting | sharpness and | saturation to high. | Contrast, Saturation, | all set to high. | SETTINGS_{—} |
| | for contrast | contrast settings to | Mid-day, full-sun, | and Sharpness all | This will in most | HIGH |
| | saturation | determine if there | any subject. | set to High. This | cases produce | |
| | sharpness and | were all set to high | Confirm focus lock. | can result in | images that look | |
| | adaptive lighting | | Capture image. | unrealistic looking | unrealistic. For a | |
| | | | | images. For a more | more natural look | |
| | | | | natural look, try | you may want to | |
| | | | | setting at least one | consider leaving | |
| | | | | of these settings to | some settings on | |
| | | | | Medium. | their normal state, | |
| | | | | | which ones will | |
| | | | | | depend on what | |
| | | | | | you are | |
| | | | | | photographing. | |
| (6B) | | | Set camera contrast, | HINT: This image | Contrast, | MANUAL_{—} |
| | | | sharpness, | was taken with | aturation, | SETTINGS_{—} |
| | | | saturation, and | Contrast, Saturation, | harpness are | HIGH_PLUS_{—} |
| | | | adaptive lighting to | Sharpness all set to | II set to high | ALT |
| | | | high. | High. Using ALT. | sing ALT. | |
| | | | Mid-day, full-sun, | This can result in | his will in most | |
| | | | any subject. | unrealistic looking | ases produce | |
| | | | Confirm focus lock. | images. For a more | mages that | |
| | | | Capture image. | natural look, try | ook unrealistic. | |
| | | | | setting at least one | or a more | |
| | | | | of these settings to | atural look you | |
| | | | | its default value. | ay want to | |
| | | | | | onsider | |
| | | | | | eaving some | |
| | | | | | ettings on their | |
| | | | | | ormal setting, | |
| | | | | | hich ones will | |
| | | | | | epend on what | |
| | | | | | ou are | |
| | | | | | hotographing. | |
| (6C) | | | Set camera contrast, | HINT: This image | Contrast, sharpness, | CONT_SHARP_{—} |
| | | | sharpness, and | was taken with | and ALT are all set to | ALT_HIGH |
| | | | adaptive lighting to | Contrast, | high. This will in | |
| | | | high. | Sharpness, and | most cases produce | |
| | | | Mid-day, full-sun, | Adaptive lighting all | images that look | |
| | | | any subject. | set to High. This | unrealistic. For a | |
| | | | Confirm focus lock. | can result in | more natural look you | |
| | | | Capture image. | unrealistic looking | may want to consider | |
| | | | | images. For a more | leaving one on the | |
| | | | | natural look, try | normal setting, which | |
| | | | | setting at least one | one will depend on | |
| | | | | of these settings to | what you are | |
| | | | | its default value. | photographing. | |
| (6D) | | | Set camera contrast, | HINT: This image | Contrast, saturation, | Enum = CONT_{—} |
| | | | saturation, & | was taken with | and ALT are all set to | SAT_ALT_{—} |
| | | | adaptive lighting to | Contrast, Saturation, | high. This will in | HIGH |
| | | | high. | and Adaptive | most cases produce | |
| | | | Mid-day, full-sun, | Lighting all set to | images that look | |
| | | | any subject. | High. This can | unrealistic. For a | |
| | | | Confirm focus lock. | result in unrealistic | more natural look you | |
| | | | Capture image. | looking images. For | may want to consider | |
| | | | | a more natural look, | leaving one on the | |
| | | | | try setting at least | normal setting, which | |
| | | | | one of these settings | one will depend on | |
| | | | | to its default value. | what you are | |
| | | | | | photographing. | |
| (6E) | | | Set camera | HINT: This image | Sharpness, | Enum = SHARP_{—} |
| | | | sharpness, | was taken with | saturation and ALT | SAT_ALT_{—} |
| | | | saturation & | Sharpness, | are all set to high. | HIGH |
| | | | adaptive lighting to | Saturation, and | This will in most | |
| | | | high. | Adaptive Lighting all | cases produce | |
| | | | Mid-day, full-sun, | set to High. This | images that look | |
| | | | any subject. | can result in | unrealistic. For a | |
| | | | Confirm focus lock. | unrealistic looking | more natural look you | |
| | | | Capture image. | images. For a more | may want to consider | |
| | | | | natural look, try | leaving one on the | |
| | | | | setting at least one | normal setting, which | |
| | | | | of these settings to | one will depend on | |
| | | | | its default value. | what you are | |
| | | | | | photographing. | |
| (7) | User sets Adaptive | Detect the ISO | Set camera ISO | HINT: This image | This image was taken | Enum = ALT_{—} |
| | Lighting to High and | speed and ALT | speed to 400 and | was taken with ISO | with the ISO Speed | AND_ISO_{—} |
| | ISO to 400 | setting | adaptive lighting to | Speed set to 400 | set to 400 and | HIGH |
| | | | high. | and Adaptive | Adaptive Lighting set | |
| | | | Mid-day, full-sun, | Lighting set to High. | to High. This can | |
| | | | any subject. | This can result in | result in highly grainy | |
| | | | Confirm focus lock. | unrealistic or grainy | (or noisy) images. | |
| | | | Capture image. | looking images. For | For better image | |
| | | | | better image quality, | quality, try setting | |
| | | | | try setting one of | one of these settings | |
| | | | | these settings to its | to its default value. | |
| | | | | default value. | | |
| (8) | The user leaves the | We will detect the | Plug in AC adapter | HINT: The camera | Digital cameras that | Enum = WARM_{—} |
| | camera on for a long | problem by the | and tum camera on | was very warm | have been on for a | CAMERA |
| | period of time, which | using temperture | for 10 minutes (or | when this image | long peroid of time | |
| | results in noisy | data kept by the | longer) with LCD on. | was captured. | will begin to degrade | |
| | pictures due to | camera, if the | To allow camera to | Digital cameras that | image quality as heat | |
| | thermal heating. | tempeture is | heat up. | have been on for a | builds up inside the | |
| | | extreme...45 | Mid-day, full-sun, | long period of time | camera. In the future | |
| | | degrees C or above. | any subject. | will begin to degrade | You may want to use | |
| | | | Set camera to ISO | image quality as | the EVF instead of | |
| | | | 100. | heat builds up inside | the Large LCD, or | |
| | | | Confirm focus lock. | the camera. For | periodically power off | |
| | | | Capture image. | best image quality, | the camera and let it | |
| | | | Repeat with camera | keep the camera | cool between periods | |
| | | | set to ISO 200 & | cool by limiting your | of long use. You can | |
| | | | 400. | use of the Image | save your working | |
| | | | | Display. | settings to expedite | |
| | | | | | your next boot up if | |
| | | | | | you should need to. | |
| (9A) | The user sets uses | Detect the problem | NA | HINT: This image | Your quality and | Enum = POOR_{—} |
| | high digital zoom | by examining the | | was taken at a low | digitial zoom settings | PRINT_{—QUALITY}_{—} |
| | magnification, which | meatadata for the | | Image Quality | are low enough that | 8 × 10 |
| | may result in poor | size of smallest | | setting or with digital | you will not get a | |
| | print quality | image that can be | | zoom, resulting in a | good 8 × 10 print. | |
| | Resolution | printed with | | lower resolution | | |
| | regardless of digital | acceptable quality | | image. The | | |
| | zoom should | for each standard | | maximum | | |
| | determine print | print size | | recommended print | | |
| | quality. | | | size for this image is | | |
| | | | | 13 × 18 cm (5″ × 7″). | | |
| (9B) | | | NA | HINT: This image | Your quality and | Enum = POOR_{—} |
| | | | | was taken with a low | digitial zoom settings | PRINT_{—} |
| | | | | Image Quality | are low enough that | QUALITY_5 × 7 |
| | | | | setting or with digital | you will not get a | |
| | | | | zoom, resulting in a | good 5 × 7 print. | |
| | | | | low resolution | | |
| | | | | image. The | | |
| | | | | maximum | | |
| | | | | recommended print | | |
| | | | | size for this image is | | |
| | | | | 10 × 15 cm (4″ × 6″). | | |
| (9C) | | | NA | HINT: This image | Your quality and | Enum = POOR_{—} |
| | | | | was taken with a low | digitial zoom settings | PRINT_{—} |
| | | | | Image Quality | are low enough that | QUALITY_4 × 6 |
| | | | | setting and/or with | you will not get a | |
| | | | | digital zoom, | good 4 × 6 print. | |
| | | | | resulting in a low | | |
| | | | | resolution image. | | |
| | | | | The maximum | | |
| | | | | recommended print | | |
| | | | | size for this image is | | |
| | | | | 9 × 13 cm (3.5″ × 5″). | | |
| (10A) | Alternate solution for | Examine digital | Set camera | HINT: This image | | |
| | above problem | zoom metadata info | resolution to 1 MP | was taken with | | |
| | to avoid message | | and digital zoom to | digital zoom, | | |
| | always coming up | | one or two levels | resulting in a lower | | |
| | for VGA, add digital | | under 1000, in | resolution image. | | |
| | zoom parameter | | Landscape & | The maximum | | |
| | | | Portrait orientation.. | recommended print | | |
| | | | Mid-day, full-sun, | size for this | | |
| | | | any subject. | resolution is 13 × 18 cm | | |
| | | | Confirm focus lock. | (5″ × 7″). | | |
| | | | Capture image. | | | |
| (10B) | | | Set camera | HINT: This image | | |
| | | | resolution to 1 MP | was taken with a | | |
| | | | and digital zoom to | significant amount of | | |
| | | | one or two levels | digital zoom, | | |
| | | | below 800, in | resulting in a low | | |
| | | | Landscape & | resolution image. | | |
| | | | Portrait orientation. | The maximum | | |
| | | | Mid-day, full-sun, | recommended print | | |
| | | | any subject. | size for this | | |
| | | | Confirm focus lock. | resolution is 10 × 15 cm | | |
| | | | Capture image. | (4″ × 6″). | | |
| (10C) | | | Set camera | HINT: This image | | |
| | | | resolution to VGA | was taken with a | | |
| | | | and digital zoom to | large amount of | | |
| | | | one or two levels | digital zoom, | | |
| | | | under 600 in | resulting in a very | | |
| | | | Landscape & | low resolution | | |
| | | | Portrait orientation.. | image. The | | |
| | | | Mid-day, full-sun, | maximum | | |
| | | | any subject. | recommended print | | |
| | | | Confirm focus lock. | size for this | | |
| | | | Capture image. | resolution is 9 × 13 cm | | |
| | | | | cm (3.5″ × 5″). | | |

1. A method for improving image capturing ability, said method comprising:
contemporaneously with the capture of an image, analyzing metadata contained within said captured image to determine which, if any, image capture parameters are in need of adjustment.

2. The method of claim 1 further comprising:
storing images where the metadata contained therein does not yield image capture parameters in need of adjustment.

3. The method of claim 1 further comprising:
providing suggestions to a user contemporaneously with said image capture, said suggestions based upon parameters determined to be in need of adjustment.

4. The method of claim 1 further comprising:
recapturing a given image based upon adjustment of parameters determined to be in need of adjustment, said recapturing and said adjustment occurring without user intervention; and
storing images where the metadata contained therein does not yield image capture parameters in need of adjustment.

5. The method of claim 4 further comprising:
concurrent with said recapturing, providing to a user an explanation of the parameters being adjusted.

6. The method of claim 1 wherein the parameter determined to be in need of adjustment are selected from the list of: use of image width, image height, number of bits per component, compression scheme, pixel composition, orientation of image, number of components, image data arrangement, subsampling ratio of Y to C, Y and C positioning, image resolution in width direction, image resolution in height direction, unit of X and Y resolution; image data location, number of rows per strip, bytes per compressed strip, offset to JPEG SOI, bytes of JPEG data, transfer function, white point chromaticity, chromaticities of primaries, color space transformation matrix coefficients, pair of black and white reference values, file change date and time, image title, image input equipment manufacturer, image input equipment model, software used, person who created the image, copyright holder.

7. A system for providing image improvement assistance, each image having associated therewith metadata pertaining to certain image capture parameters, said system comprising:
analyzation capability for examining said metadata associated with an image that is in the process of being stored, and
reporting image improvement assistance for an image to a user based upon said analyzation of said metadata associated with said image, said reporting occurring contemporaneously with said storage of said image.

8. The system of claim 7 wherein said image improvement assistance includes suggestions with respect to at least one of the following: use of image width, image height, number of bits per component, compression scheme, pixel composition, orientation of image, number of components, image data arrangement, subsampling ration of Y to C, Y and C positioning, image resolution in width direction, image resolution in height direction, unit of X and Y resolution; image data location, number of rows per strip, bytes per compressed strip, offset to JPEG SOI, bytes of JPEG data, transfer function, white point chromaticity, chromaticities of primaries, color space transformation matrix coefficients, pair of black and white reference values, file change date and time, image title, image input equipment manufacturer, image input equipment model, software used, person who created the image, copyright holder.

9. The system of claim 7 further comprising:
a processor for controlling the adjustment of at least one parameter associated with said image, said adjustment occurring as a result of an image being examined.

10. The system of claim 9 wherein said processor is further operable for enabling the reimaging of said image in accordance with said adjustment.

11. A system for analyzing a digital image, said system comprising:
a sensor for capturing image data along with metadata pertaining to each captured image;
logic for dynamically analyzing the image data as a function of said metadata pertaining thereto; and
a display for communicating to a user at the time an image is captured suggestions for image improvement, said suggestions based upon the results of said analyzing.

12. The system of claim 11 wherein said metadata comprise both image and device metadata.

13. A method for analyzing a digital image, said method comprising:
dynamically analyzing metadata pertaining to said digital image to determine acceptability of said image; and
communicating to a user possible image corrections for images analyzed to be unacceptable.

14. The method of claim 13 further comprising:
electronically recapturing an image analyzed to be unacceptable, said recapturing occurring after at least one parameter associated with said metadata pertaining to said image has been adjusted.

15. The method of claim 14 wherein said parameter adjustment is performed without user intervention.

16. A digital camera comprising:
means for adjusting a plurality of parameters, said parameters affecting the quality of each image captured by said camera;
said adjusting means operable for receiving metadata associated with each said captured image, said metadata pertaining to said parameters; and
said adjusting means further operable for providing a message to a user when said reviewed metadata determines that an image could have its quality improved upon by an adjustment of at least one of said parameters, said message indicating which parameters are in need of adjusting.

17. The digital camera of claim 16 wherein said adjusting means is further operable for adjusting at least one of said parameters in need of adjusting and recapturing said image using said readjusted parameters.

18. The digital camera of claim 17 wherein said parameters are selected from the list of: use of image width, image height, number of bits per component, compression scheme, pixel composition, orientation of image, number of components, image data arrangement, subsampling ration of Y to C, Y and C positioning, image resolution in width direction, image resolution in height direction, unit of X and Y resolution; image data location, number of rows per strip, bytes per compressed strip, offset to JPEG SOI, bytes of JPEG data, transfer function, white point chromaticity, chromaticities of primaries, color space transformation matrix coefficients, pair of black and white reference values, file change date and time, image title, image input equipment manufacturer, image input equipment model, software used, person who created the image, copyright holder.

19. The digital camera of claim 16 further comprising:
means for displaying provided ones of said messages.

20. The digital camera of claim 17 wherein said adjusting means continues to adjust said parameters with respect to an image until a determination is made that further adjustments are not likely to improve image quality.
